(19) United States
(12) Patent Application Publication
(10) Pub. No.: US 2019/0141094 A1
(43) Pub. Date: May 9, 2019

(54) MULTI-SUBSCRIPTION IN INTERNET PROTOCOL MULTIMEDIA SUBSYSTEMS

(71) Applicant: Telefonaktiebolaget LM Ericsson (publ), Stockholm (SE)

(72) Inventors: David CASTELLANOS ZAMORA, Madrid (ES); Trìnídad CASTILLO CASERO, Madrid (ES); Jerker ZETTERLUND, Bromma (SE)

(21) Appl. No.: 16/307,332

(22) PCT Filed: Jun. 9, 2016
(86) PCT No.: PCT/EP2016/063217

§ 371 Date: Dec. 5, 2018

(51) Int. Cl. H04L 29/06

(52) U.S. Cl. CPC H04L 65/1073; H04L 65/1006; H04L 65/1016

(57) ABSTRACT

Methods and apparatus for implementing a Home Subscriber Server, HSS, (102, 200) a Serving Call Session Control Function, S-CSCF, (110, 300) and an Internet Protocol Multimedia Subsystem Application Server, IMS AS, (112, 400) in an Internet Protocol Multimedia Subsystem, IMS. The HSS comprises multi-subscription data for a user with a plurality of devices (100a, 100b, 100c). The multi-subscription data comprises a private identifier assigned for each of the plurality of devices and a common set of one or more public identifiers associated with each private identifier assigned for each of the plurality of devices. The S-CSCF transmits to the HSS a message for assigning a server in the IMS to a device. The HSS determines, based on a private identifier and multi-subscription data in the message, a multi-subscription indicator indicating whether the received private identifier is related to a multi-subscription. The HSS transmits a response to the received message comprising the multi-subscription indicator. The S-CSCF generates a registration token for the device in dependence on the multi-subscription indicator and transmits the registration token and the multi-subscription indicator to the IMS Application Server, IMS AS. The IMS AS transmits a request to the HSS for a private identifier and a device type for each device related to the multi-subscription and comprising a public identifier for the device. The private identifiers and device types are received from the HSS and associated with each other.

### TECHNICAL FIELD

The invention relates to methods and apparatus for the implementation of multi-subscriptions in an Internet Protocol Multimedia Subsystem (IMS).

### BACKGROUND

In existing IMS deployments, an end-user is enabled to use a plurality of User Equipments (UE) or devices, each one using individual private identifiers (e.g. an IMS Private Identifier (IMPI)), and to access profiles including authentication/authorization information for a device to access the IMS subsystem on a per IMPI basis.

In addition, there is a desire to provide a homogeneous IMS Telephony service across all of the devices available within the device bundle of a given user for a multi-subscription. To achieve that, all the devices/IMPIs in the device bundle are associated within a multi-subscription, each device/IMPI being associated with a common set of public identifiers (e.g. IMS Public Identifiers (IMPU)) and service profiles (including applicable triggers to IMS telephony Application Servers (AS) that shall be triggered, e.g. a Multimedia Telephony AS (MMTel AS) or a Service Centralisation and Continuity Application Server (SCC AS)) and a single set of settings for the IMS Telephony service (e.g. barring, diversion, presentation services).

In the context of an IMS Multimedia Telephony service offered via cellular access (e.g. Voice over Long Term Evolution (VoLTE)), Evolved Packet Core (EPC) integrated WiFi access (e.g. WiFi Calling) and/or directly from any general purpose Internet Protocol (IP) connection (i.e. fixed IMS, untrusted WiFi etc.), the different devices an end-user may use could have different capabilities (e.g. IR.92 or IR.51 compliant).

As used herein, the term “multi-subscription” encompasses a user IMS subscription allowing the use of a plurality of devices for the user.

Industry has been working in recent years to design, develop and deploy the next generation of telephony/communication services based on an IMS service platform including voice, video, messaging and other applications that IMS can enable.

IMS based voice/video services are being delivered in the first place primarily over a Mobile Broadband LTE access, the so called VoLTE, and lately, Voice over an EPC integrated untrusted WiFi access, the so called WiFi Calling service, has been deployed with great success in the market.

In this situation, compliant UEs according to Global System for Mobile Communications (GSM) Association (GSMA) IR.92 [4] and IR.51 [3] can use the IMS voice (and video) service indistinctively and seamlessly either from an LTE or untrusted WiFi connection. Compliant UEs according to GSMA IR.92 [4] and IR.51 [3] are typically Subscriber Identity Module (SIM) based UEs.

By way of background, FIG. 1 shows an architecture for a network supporting IMS based voice (and video) service using a converged EPC system integrating both LTE (VoLTE) and untrusted non-3GPP WiFi access (WiFi Calling).

Existing Wi-Fi calling solutions have been recently complemented with a new functionality, Wi-Fi calling for multi-device. This functionality enables operators to extend voice service coverage from SIM-based smartphones to millions of non-SIM Wi-Fi-only devices such as tablets and personal computers, creating value for consumers worldwide and bringing operators new business opportunities.

With Wi-Fi calling for multi-device, consumers can use devices that have only Wi-Fi access capabilities to make regular voice calls over any Wi-Fi network. The consumer's personal devices can be located at different Wi-Fi access points anywhere in the world, while their smartphone can be on cellular access or any Wi-Fi access point, and consumers can choose to pick up calls on any of the devices.

The Wi-Fi calling for multi-device feature is a solution which is based to a large extent on the use of standardized interfaces and functions. There is no standard dealing so far with the technical details of this particular use case. GSMA has recently started a group on this matter.

In addition to this, it is also expected that other non-SIM devices (e.g. Web Real Time Communication (webRTC) clients running on Personal Computers (PC)) could also connect via any IP connection towards an integrated IMS based service.

There are therefore three principal types of devices that a multi-subscription can have, although others may be defined in future:
Primary 1 (P1) device: Typically, this will be a mobile/smart phone. A primary device may have one or more of the following telephony capabilities: VoLTE, VoWiFi, and Circuit Switched (CS);
Secondary 1 (S1) device: A non-telephony (e.g. without a SIM) device that is connected via the EPC by means of Wi-Fi access point. An S1 device may be a “tablet” using VoWiFi (3GPP S2b);
Secondary 2 (S2) device: A non-telephony device that is connected via the Internet, typically by means of WLAN. An S2 device may be a PC, tablet or even an IAD using standard MMTel signaling.

Secondary devices require specific private user identifiers, e.g. an IMPI, used during EPC attach and/or IMS registration (IMS REG) procedures but may reuse the same public identifiers (e.g. a Mobile Subscriber Integrated Service Digital Network Number (MSISDN) or an IMPU) as the P1 device. In exemplary arrangements, S1/S2 devices make and receive calls from/to the same public identity (e.g. MSISDN or IMPU) used by a P1 device and execute the same originating and terminating services. This can result in use of the same IMS based voice service profile and the same user experience when a call is from S1/S2 device as it would be from the P1 device.

Typically, within an IMS multi-subscription, each device is provided with an individual IMPI and a corresponding IMPU used at IMS REG only. Each device also is provided with a corresponding IMS profile to access the IMS authentication and authorization. All of the devices/IMPIs in the multi-subscription will make use of a single set IMPUs and IMS Telephony service profile settings.

An MMTel AS stores a profile for an IMS Telephony service of each subscriber in an HSS as transparent data. This profile is fetched and updated using standard Sh interface procedures for repository data. Additionally, the MMTel AS and SCC-AS make use of the Sh interface to fetch non-transparent data such as Circuit Switch Domain Routing Number (CSRN), Terminating Access Domain Selection (TADS) and Correlation Mobile Subscriber Integrated Service Digital Network Number (C-MSISDN) amongst others.

In scenarios where a set of IMPUs are shared amongst a number of IMPIs in a multi-subscription, Sh requests for some of the data that can be fetched from the HSS may require the indication of the IMPI in the request in addition to the IMPU. In particular, relevant Sh requests for VoLTE and WiFi calling typically require both IMPU and IMPI in Sh requests where the IMPU is shared amongst multiple IMPIs, e.g. Sh requests for Location, MSISDN, TADS, UE Single Radio Voice Call Continuity (SRVCC) Capabilities, Session Transfer Number for SRVCC (STN-SR), and CSRN. Refer to 3GPP TS 29.328 for additional information on these requests.

In an IMS multi-subscription scenario, it is therefore required that the MMTel AS and/or SCC AS knows about IMPIs used by a common set of IMPUs. This is possible during IMS Registration where the IMS core can be configured to provide the IMS AS with an IMPI for a device during 3^{rd} party REG in combination with a Registration Token mechanism defined in 3GPP TS 24.229. During initial IMS REG, the Serving Call Session Control Function (S-CSCF) is configured to generate a Registration Token for the IMPI which is provided to the IMS AS during 3^{rd} party REG and any other Session Internet Protocol (SIP) signaling originated from that IMPI. This is a way for an IMS AS to correlate SIP procedures for a particular IMPI. Terminating INVITES will however not include the Registration Token.

Different access and call control functions for IMS based voice services require the knowledge of the location information of the corresponding user. In a number of cases, the location information that the UE includes within signaling to the IMS, the so called User Provided Location Information, is insufficient for this purpose so the network needs to provide/fetch user location information, the so called Network provided Location Information (NPLI). This is especially of interest in relation to regulatory requirements (i.e. emergency calls and Lawful Interception).

3GPP has defined procedures to enable NPLI for cellular access (e.g. LTE access). However for non-3GPP accesses, and in particular for untrusted WiFi accesses, there is no mechanism for NPLI defined, and possibilities to have one defined are low from a technical point of view.

The lack of location knowledge in an HSS, in an IMS core and ultimately in a relevant IMS AS presents the following drawbacks.
In a system where IMS multi-subscriptions are defined, an S-CSCF needs to be configured to generate a Registration Token. However, the S-CSCF generates a Registration Token in all cases, even for devices or IMPIs that do not belong to an IMS multi-subscription and even if the Registration Token is not required for any other purpose. This implies a waste of processing resources in the S-CSCF and IMS ASs.
There is no mechanism for providing NPLI for devices connected over untrusted WiFi access because non-SIM secondary devices can only connect via WiFi.
Triggering NPLI procedures for secondary devices may lead to
   Registration procedures not being able to be successfully completed and
   A waste of signaling in each case.
In an IMS multi-subscription scenario, an MMTel AS and a SCC AS require the use of an IMPI in relevant Sh requests towards the HSS (e.g. Location, TADS, CSRN). When a P1 device and S1/S2 devices are registered, it is assumed that both the MMTel AS and the SCC AS are aware of the IMPI as received in 3rd party REG.
At the reception of Terminating INVITEs towards an IMPU related to an IMS multi-subscription while the IMPU is in an UNREGISTERED state, the MMTel AS and the SCC-AS may still have the need to progress the terminating INVITE towards a particular IMPI/device (e.g. in the typical case of CS breakout to P1 devices in CS coverage only). However, in this situation the MMTel AS and the SCC-AS have no means to get hold of the IMPI to execute Sh interactions appropriately towards the HSS.
Finally, access network information relevant for charging and Lawful Interception purposes is received from a Policy and Charging Control (PCC) architecture or Proxy Call Session Control Function (P-CSCF) which consumes extra resources, introduces extra delay in call signaling and/or requires configuration of different entry points in the network for different device types.

### SUMMARY

Exemplary methods and apparatus disclosed herein are aimed at overcoming or mitigating one or more problems associated with the prior art including those mentioned above.

The inventors have appreciated that while the IMS subscription as currently defined in 3GPP already provides basic support for multi-subscription, it does not provide explicit information about whether a given IMPI belongs to a multi-subscription and/or whether the particular IMPI relates to the use of a P1, S1 or S2 device (i.e. basically whether the corresponding IMSI is allowed to access 3GPP RATs and, if not, whether the IMS user is making use of EPC integrated WiFi access or not). The current definition of involved interfaces and IMS user profiles (access, service and voice service profiles) lacks relevant support for making the IMS Core and the IMS ASs aware of whether signaling procedures related to an individual device (or IMPI), or to a given public identity (or IMPU), relate to an IMS user with a multi-subscription or not. Furthermore, the IMS Core and the IMS ASs lack full details regarding the capabilities of each device within an IMS multi-subscription in some situations.

Exemplary methods and apparatus disclosed herein provide the IMS Core Network with capabilities to distinguish that a particular signaling flow is related to an IMPI/IMPU that belongs to an IMS multi-subscription and whether the IMPI relates to a primary or secondary device. This allows the correct realization of all network procedures (e.g. location, TADS, CSRN queries over Sh) and additional optimizations in the execution of procedures, e.g. generation of Registration Token only for IMPIs belonging to multi-subscriptions and triggering NPLI only for primary devices.

According to the invention in an aspect, there is provided a network node for use as a Home Subscriber Server, HSS, in an Internet Protocol Multimedia Subsystem, IMS. The network node comprises multi-subscription data for a user with a plurality of devices, the multi-subscription data comprising a private identifier assigned for each of the plurality of devices and a common set of one or more public identifiers associated with each private identifier assigned for each of the plurality of devices. The network node comprises a receiving means, which may be a receiver, configured to receive from a further node a message for assigning a server in the IMS to one of the plurality of devices, the message comprising a private identifier for the device and a public identifier included in the common set of one or more public identifiers. The network node comprises a device subscription determining means, which may be a device subscription determiner, configured to determine, based on the received private identifier and the multi-subscription data, a multi-subscription indicator indicating whether the received private identifier is related to a multi-subscription, and to control a transmitter to transmit to the further node a response to the received message, the response comprising the multi-subscription indicator.

Optionally, the multi-subscription data further comprises a subscription type assigned for each of the plurality of devices, the subscription type indicating that the device is related to the multi-subscription, and wherein the device subscription determiner is further configured to determine, based on the received private identifier and the subscription type assigned for the device, the multi-subscription indicator for inclusion in the response.

Optionally, the receiver is configured to receive from an IMS Application Server, IMS AS, a request for a private identifier and a device type for each device related to the multi-subscription, the request comprising a public identifier included in the common set of one or more public identifiers. The network node further comprising: a device type determining means, which may be a device type determiner, configured to: determine, based on the received public identifier and the multi-subscription data, the private identifier for each device related to the multi-subscription; if access subscription data is available for an access network through which one or more devices related to the multi-subscription can access the IMS, determine, based on the access subscription data and the multi-subscription data, a device type indicating an access capability for each of these one or more devices related to the multi-subscription; if access subscription data is not available for one or more devices related to the multi-subscription, determine, based on the multi-subscription data, a device type indicating a direct access capability to access the IMS for each of these one or more devices related to the multi-subscription. The device type determining means further configured to control the transmitter to transmit the determined private identifiers and device types to the IMS AS.

Optionally, the multi-subscription data further comprises a device type assigned for each of the plurality of devices, the device type indicating an access capability of each device. The receiver is configured to receive from an IMS Application Server, IMS AS, a request for a private identifier and a device type for each device related to the multi-subscription, the request comprising a public identifier included in the common set of one or more public identifiers. The network node further comprises a device type determining means, which may be a device type determiner, configured to determine the private identifier and the device type for each device related to the multi-subscription, based on the received public identifier and the multi-subscription data, and to control the transmitter to transmit the determined private identifiers and device types to the IMS AS.

Optionally, the device types indicate an access capability of a device as one or more of: cellular access; circuit switched access; Wi-Fi access; Evolved Packet System, EPS; and internet access.

According to the invention in an aspect, there is provided a method for operating a network node for use as a Home Subscriber Server, HSS, in an Internet Protocol Multimedia Subsystem, IMS. The network node comprises multi-subscription data for a user with a plurality of devices. The multi-subscription data comprises a private identifier assigned for each of the plurality of devices and a common set of one or more public identifiers associated with each private identifier assigned for each of the plurality of devices. The method comprises receiving, by a receiver from a further node, a message for assigning a server in the IMS to one of the plurality of devices, the message comprising a private identifier for the device and a public identifier included in the common set of one or more public identifiers. The method also comprises determining, by a device subscription determiner and based on the received private identifier and the multi-subscription data, a multi-subscription indicator indicating whether the received private identifier is related to a multi-subscription. The method also comprises controlling, by the device subscription determiner, a transmitter to transmit to the further node a response to the received message, the response comprising the multi-subscription indicator.

Optionally, the multi-subscription data further comprises a subscription type assigned for each of the plurality of devices, the subscription type indicating that the device is related to the multi-subscription, and wherein the method further comprises the device subscription determiner determining, based on the received private identifier and the subscription type assigned for the device, the multi-subscription indicator for inclusion in the response.

Optionally, the method further comprises receiving, by the receiver from an IMS Application Server, IMS AS, a request for a private identifier and a device type for each device related to the multi-subscription, the request comprising a public identifier included in the common set of one or more public identifiers. The method further comprises determining, by a device type determiner and based on the received public identifier and the multi-subscription data, the private identifier for each device related to the multi-subscription. If access subscription data is available for an access network through which one or more devices related to the multi-subscription can access the IMS, the device type determiner determines, based on the access subscription data and the multi-subscription data, a device type indicating an access capability for each of these one or more devices related to the multi-subscription. If access subscription data is not available for one or more devices related to the multi-subscription, the device type determiner determines, based on the multi-subscription data, a device type indicating a direct access capability to access the IMS for each of these one or more devices related to the multi-subscription. The method further comprises controlling, by the device type determiner, the transmitter to transmit the determined private identifiers and device types to the IMS AS.

Optionally, the multi-subscription data further comprises a device type assigned for each of the plurality of devices, the device type indicating an access capability of each device. The method further comprises receiving, by the receiver and from an IMS Application Server, IMS AS, a request for a private identifier and a device type for each device related to the multi-subscription, the request comprising a public identifier included in the common set of one or more public identifiers. The method further comprises determining, by a device type determiner, the private identifier and the device type for each device related to the multi-subscription, based on the received public identifier and the multi-subscription data. The method further comprises controlling, by the device type determiner, the transmitter to transmit the determined private identifiers and device types to the IMS AS.

Optionally, the device types indicate an access capability of a device as one or more of: cellular access; circuit switched access; Wi-Fi access; Evolved Packet System, EPS; and internet access.

According to the invention in an aspect, there is provided a network node for use as a Serving Call Session Control Function, S-CSCF, in an Internet Protocol Multimedia Subsystem, IMS, wherein a user with a plurality of devices holds a subscription in a Home Subscriber Server, HSS, of the IMS, the subscription comprising a private identifier assigned for each of the plurality of devices and one or more public identifiers associated with the private identifiers assigned for the plurality of devices. The network node comprises a transmitting means, which may be a transmitter, configured to transmit to the HSS a message for assigning a server in the IMS to a device, the message comprising a private identifier and a public identifier for the device. The network node further comprises a receiving means, which may be a receiver configured to receive a response to the transmitted message, the response comprising a multi-subscription indicator indicating whether the device is related to a multi-subscription. The network node further comprises a registration token generating means, which may be a registration token generator configured to generate a registration token for the device in dependence on the received multi-subscription indicator indicating that the device is related to a multi-subscription. The registration token generator is further configured to control the transmitter to transmit the registration token and the multi-subscription indicator to an IMS Application Server, IMS AS.

Optionally, the registration token comprises the multi-subscription indicator.

According to the invention in an aspect, there is provided a method for operating a network node for use as a Serving Call Session Control Function, S-CSCF, in an Internet Protocol Multimedia Subsystem, IMS, wherein a user with a plurality of devices holds a subscription in a Home Subscriber Server, HSS, of the IMS, the subscription comprising a private identifier assigned for each of the plurality of devices and one or more public identifiers associated with the private identifiers assigned for the plurality of devices. The method comprises transmitting, by a transmitter to the HSS, a message for assigning a server in the IMS to a device, the message comprising a private identifier and a public identifier for the device. The method further comprises receiving, by a receiver, a response to the transmitted message, the response comprising a multi-subscription indicator indicating whether the device is related to a multi-subscription. The method further comprises generating, by a registration token generator, a registration token for the device in dependence on the received multi-subscription indicator indicating that the device is related to a multi-subscription. The method further comprises controlling, by the registration token generator, the transmitter to transmit the registration token and the multi-subscription indicator to an IMS Application Server, IMS AS.

Optionally, the registration token comprises the multi-subscription indicator.

According to the invention in an aspect, there is provided a network node for use as an Internet Protocol Multimedia Subsystem Application Server, IMS AS, in an IMS, wherein a user with a plurality of devices holds a subscription in a Home Subscriber Server, HSS, of the IMS, the subscription comprising a private identifier assigned for each of the plurality of devices and one or more public identifiers associated with the private identifiers assigned for the plurality of devices. The network node comprises a receiving means, which may be a receiver, configured to receive from a further node a registration token for a device, and a multi-subscription indicator indicating whether the device is related to a multi-subscription. The network node comprises a device type requesting means, which may be a device type requester, configured to control a transmitter to transmit a request to the HSS, the request being for a private identifier and a device type for each device related to the multi-subscription, the request comprising a public identifier for the device. The receiver is further configured to receive from the HSS the requested private identifiers and device types related to the multi-subscription. The network node comprises a device type associating means, which may be a device type associator configured to associate each private identifier with a device type related to the multi-subscription.

Optionally, the registration token comprises the multi-subscription indicator.

According to the invention in an aspect, there is provided a method for operating a network node for use as an Internet Protocol Multimedia Subsystem Application Server, IMS AS, in an IMS, wherein a user with a plurality of devices holds a subscription in a Home Subscriber Server, HSS, of the IMS, the subscription comprising a private identifier assigned for each of the plurality of devices and one or more public identifiers associated with the private identifiers assigned for the plurality of devices. The method comprises receiving, by a receiver from a further node, a registration token for a device, and a multi-subscription indicator indicating whether the device is related to a multi-subscription. The method comprises controlling, by a device type requester, a transmitter to transmit a request to the HSS, the request being for a private identifier and a device type for each device related to the multi-subscription, the request comprising a public identifier for the device. The method comprises receiving, by the receiver and from the HSS, the requested private identifiers and device types related to the multi-subscription. The method comprises associating, by a device type associator, each private identifier with a device type related to the multi-subscription.

Optionally, the registration token comprises the multi-subscription indicator.

According to the invention in an aspect, there is provided a network node for use as a Home Subscriber Server, HSS, in an Internet Protocol Multimedia Subsystem, IMS, wherein the network node comprises multi-subscription data for a user with a plurality of devices, the multi-subscription data comprising a private identifier assigned for each of the plurality of devices and a common set of one or more public identifiers associated with the private identifiers assigned for the plurality of devices. The network node comprises a receiving means, which may be a receiver, configured to receive from a further node a message for authorising a device in the IMS, the message comprising a private identifier for the device and a public identifier included in the common set of one or more public identifiers. The network node comprises a device type determining means, which may be a device type determiner configured to determine a device type for the device based on the received private identifier and the multi-subscription data, the device type indicating an access capability for the device to access the IMS. The network node comprises a device subscription determining means, which may be a device subscription determiner, configured to determine, based on the received private identifier and the multi-subscription data, a multi-subscription indicator indicating that the received private identifier is related to a multi-subscription. The network node comprises a device locating means, which may be a device locator, configured, in dependence on at least one of the device type and the multi-subscription indicator indicating the multi-subscription, to transmit, via a transmitting means, which may be a transmitter, a message requesting location data for one or more devices related to the multi-subscription, and receive, via the receiver, location data for at least one of the one or more devices related to the multi-subscription. The transmitter is configured to transmit to the further node a response to the received message, the response being based on the location data received for the at least one of the one or more devices related to the multi-subscription.

Optionally, the device type determiner is configured to: if access subscription data is available for an access network through which the device can access the IMS, determine, based on the access subscription data, a device type indicating an access capability for the device related to the multi-subscription; if access subscription data is not available for the device, determine a device type indicating a direct access capability to access the IMS for the device related to the multi-subscription.

Optionally, the multi-subscription data further comprises a device type assigned for each of the plurality of devices; and wherein the device type determiner is configured to determine the device type assigned for the device.

Optionally, the multi-subscription data further comprises a subscription type assigned for each of the plurality of devices, the subscription type indicating that the device is related to the multi-subscription, and wherein the device subscription determiner is configured to determine the multi-subscription indicator based on the subscription type assigned for the device.

Optionally, the device types indicate an access capability of a device as one or more of: cellular access; circuit switched access; Wi-Fi access; Evolved Packet System, EPS; and internet access.

Optionally, the device locator is configured to transmit the request for location data relating to the device in dependence on the device having a cellular access capability.

Optionally, if the device does not have a cellular access capability, the device locator is configured to transmit the request for location data relating to a different device related to the multi-subscription and having a cellular access capability.

According to the invention in an aspect, there is provided a method for operating a network node for use as a Home Subscriber Server, HSS, in an Internet Protocol Multimedia Subsystem, IMS, wherein the network node comprises multi-subscription data for a user with a plurality of devices, the multi-subscription data comprising a private identifier assigned for each of the plurality of devices and a common set of one or more public identifiers associated with the private identifiers assigned for the plurality of devices. The method comprises receiving, by a receiver and from a further node, a message for authorising a device in the IMS, the message comprising a private identifier for the device and a public identifier included in the common set of one or more public identifiers. The method comprises determining, by a device type determiner, a device type for the device based on the received private identifier and the multi-subscription data, the device type indicating an access capability for the device to access the IMS. The method comprises determining, by a device subscription determiner and based on the received private identifier and the multi-subscription data, a multi-subscription indicator indicating that the received private identifier is related to a multi-subscription. The method comprises, in dependence on at least one of the device type and the multi-subscription indicator indicating the multi-subscription, transmitting, by a device locator via a transmitter, a message requesting location data for one or more devices related to the multi-subscription. The method comprises receiving, by the device locator via the receiver, location data for at least one of the one or more devices related to the multi-subscription. The method comprises transmitting, by the transmitter and to the further node, a response to the received message, the response being based on the location data received for the at least one of the one or more devices related to the multi-subscription.

Optionally, the method further comprises, if access subscription data is available for an access network through which the device can access the IMS, determining by the device type determiner, based on the access subscription data, a device type indicating an access capability for the device related to the multi-subscription, and if access subscription data is not available for the device, determining by the device type determiner a device type indicating a direct access capability to access the IMS for the device related to the multi-subscription.

Optionally, the multi-subscription data further comprises a device type assigned for each of the plurality of devices, the method further comprising determining by the device type determiner the device type assigned for the device.

Optionally, the multi-subscription data further comprises a subscription type assigned for each of the plurality of devices, the subscription type indicating that the device is related to the multi-subscription, and the method further comprising determining by the device subscription determiner the multi-subscription indicator based on the subscription type assigned for the device.

Optionally, the device types indicate an access capability of a device as one or more of: cellular access; circuit switched access; Wi-Fi access; Evolved Packet System, EPS; and internet access.

Optionally, transmitting, by the device locator, the request for location data relating to the device is in dependence on the device having a cellular access capability.

Optionally, if the device does not have a cellular access capability, transmitting, by the device locator, the request for location data is for a different device related to the multi-subscription and having a cellular access capability.

According to the invention in an aspect, there is provided a computer program comprising instructions which, when executed on at least one processor, cause the at least one processor to carry out any method described above or anywhere herein.

According to the invention in an aspect, there is provided a carrier containing any computer program mentioned above, wherein the carrier is one of an electronic signal, optical signal, radio signal, or non-transitory computer readable storage medium.

### BRIEF DESCRIPTION OF THE DRAWINGS

Exemplary embodiments of the invention are discussed herein with reference to the accompanying drawings, in which:

FIG. 1 is an architecture diagram showing an exemplary network infrastructure including IMS network nodes;

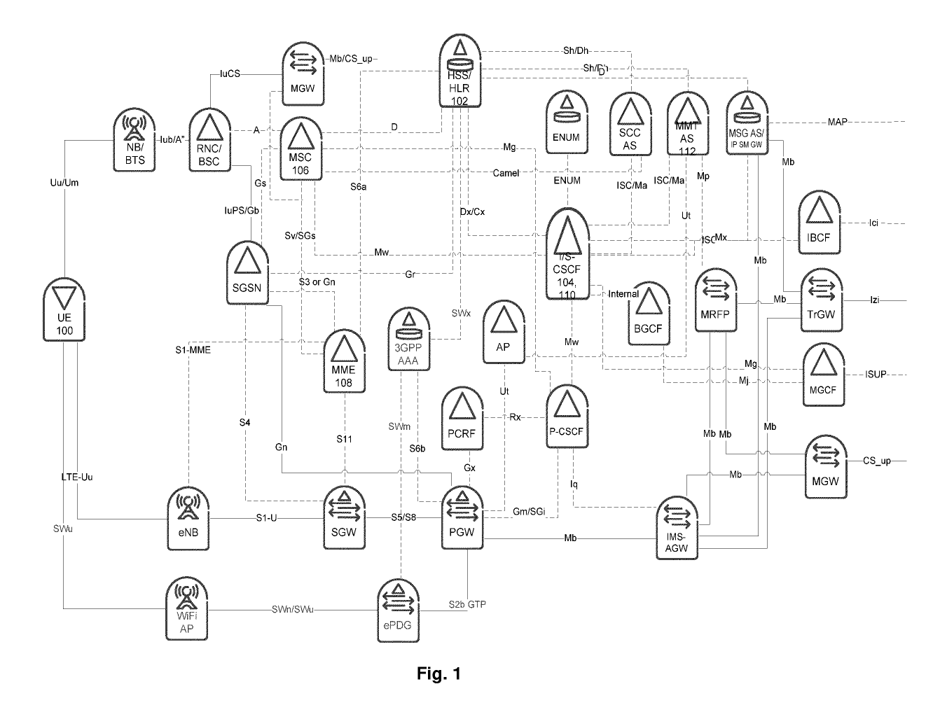

FIG. 2 is a schematic diagram of a HSS;

FIG. 3 is a schematic diagram of a S-CSCF;

FIG. 4 is a schematic diagram of an IMS AS;

FIG. 5 includes signaling flows for authorisation of a UE in an IMS;

FIG. 6 includes signaling flows for registration of a UE in an IMS; and

FIG. 7 includes signaling flows for retrieval of a private identifier and a device type of a UE data from a HSS.

### DETAILED DESCRIPTION

Generally, disclosed herein are methods and apparatus for providing an indication to an IMS network whether a particular device is part of an IMS multi-subscription. The methods and apparatus may also provide an indication of a type of device. In specific exemplary arrangements, a private identifier for a device may include data allowing the retrieval of such indications. A number of nodes in the IMS network are able to use the indication in a number of ways to increase efficiencies in the IMS network.

Methods and apparatus disclosed provide a definition of an IMS subscription type in order to store a more explicit understanding in the HSS of whether a given IMPI belongs to an IMS multi-subscription. Methods and apparatus disclosed may also provide a definition of whether the IMPI relates to a primary (e.g. P1) device type or secondary (e.g. S1 or S2) device type. There are thus provided methods and apparatus for handling a multi-subscription within an IMS subscription for a plurality of devices whereby the IMS core network is provided with capabilities to determine whether a particular signaling flow is related to a device of the IMS multi-subscription and whether the device is of one type or another.

From a high level, exemplary methods may comprise one or more of the following steps. Further, exemplary apparatus may be configured to undertake one or more of the following steps.
Defining, at a HSS, a multi-subscription with an IMS subscription for a plurality of devices, wherein each of the plurality of devices is associated with the multi-subscription and a device type and is assigned a particular private identifier and a particular access profile to access the IMS through a particular access network, and wherein the device type implies an access enabled for the device.
Optionally, the device type may indicate the use of any one of: i) a cellular access, a CS access, a Wi-Fi access, and any combination thereof; and ii) EPS with Wi-Fi access; and iii) internet access.
Associating, at the HSS, a common set of public identifiers with a common service profile and with the plurality of devices.
Optionally, the common set of public identifiers includes public identifiers to be respectively used by the plurality of devices at IMS registration. In exemplary arrangements the common set of public identifiers may be an Implicit Registration Set (IRS).
Optionally, the common set of public identifiers includes a default public identifier to be used in selected call procedures.
During IMS registration of a device with a registered private identifier and public identifier, applying access control mechanisms at the HSS based on the associated device type and the assigned access profile for the device identified by the registered private identifier.
For example, the HSS might decide if user location based on a 3GPP cellular network is an applicable input for IMS Access authorization procedures based on the device type stored in the HSS and identified by the private identifier, which may be an IMPI. For example, 3GPP cellular location is not applicable for device types implying that cellular access is not available.
During IMS registration of the device with the registered private identifier and public identifier, submitting by the HSS, and receiving by a S-CSCF, the common set of public identifiers and the common service profile associated with the registered private identifier, the associated device type and a multi-subscription indicator.
Triggering, from the S-CSCF, one or more procedures to be applied based on the device type associated with the registered private identifier and the multi-subscription indicator.
For example, the S-CSCF might decide to generate a Registration Token during IMS Registration only for IMPIs that are identified as being part of an IMS multi-subscription based on the multi-subscription indication provided by the HSS over a Cx interface.
When an IMS AS is triggered, amongst the one or more triggered procedures, submitting from the S-CSCF, and receiving by the IMS AS, the common set of public identifiers and the common service profile associated with the registered private identifier, the associated device type and the multi-subscription indicator.
Defining a multi-subscription indication within the AS service profile stored in the HSS as transparent data in order to make the AS aware that a particular IMPU belongs to a multi-subscription during the handling of terminating calls while none of the related devices/IMPIs are registered in the IMS.
Triggering, from the IMS AS, procedures to retrieve the multi-subscription information stored in the HSS (i.e. IMPIs and corresponding device types belonging to the multi-subscription).
Triggering, from the AS, one or more procedures to be applied based on a call case and the device types of the associated devices/IMPIs within the multi-subscription.
For example, an MMTel AS could apply the following logic:
   Trigger NPLI requests based on device type (e.g. only for devices types with 3GPP cellular access capabilities);
   Apply charging control for specific device types without the need to fetch additional info from access network (e.g. S2 devices assumed to be fixed access); and/or
   Complete call termination procedures to relevant devices within the multi-subscription appropriately based on device type (i.e. break out to CS for legacy devices).

Exemplary methods and apparatus disclosed herein provide for the inclusion of two new indicators at a private identifier (e.g. IMPI) level as follows:
A “multi-subscription indicator” for each IMPI defined within an IMS multi-subscription;
A “device type indicator” for each IMPI defined within an IMS multi-subscription indicating whether the IMPI relates to a primary or secondary (e.g. S1 or S2) device.

Optionally, the IMS Telephony Service profile associated to the default IMPU of the multi-subscription may also include a “multi-subscription indicator”.

In exemplary arrangements, one or more of the following basic principles might apply for the new indicators.
It is the private identifier (e.g. IMPI) associated with a device for an IMS user that is identified to belong to an IMS multi-subscription and/or to a primary or secondary device type.
The definition of a “device type” may provide an implicit indication that an IMPI belongs to an IMS multi-subscription, i.e. a separate “multi-subscription indicator” per IMPI may not be required if all IMPIs within the multi-subscription include its corresponding “device type indicator”.
NOTE: Even the device type indication could be managed implicitly in the HSS based on allowed Radio Access Technology (RAT) types for the corresponding IMSI of each IMPI belonging to an IMS Multi-Subscription. However for illustration purposes methods and apparatus disclosed herein will describe identifiers as being explicitly defined within the IMS subscription.
Absence of the proposed indicators may be understood to mean that a given IMPI/IMPU is related to a single IMS subscription.

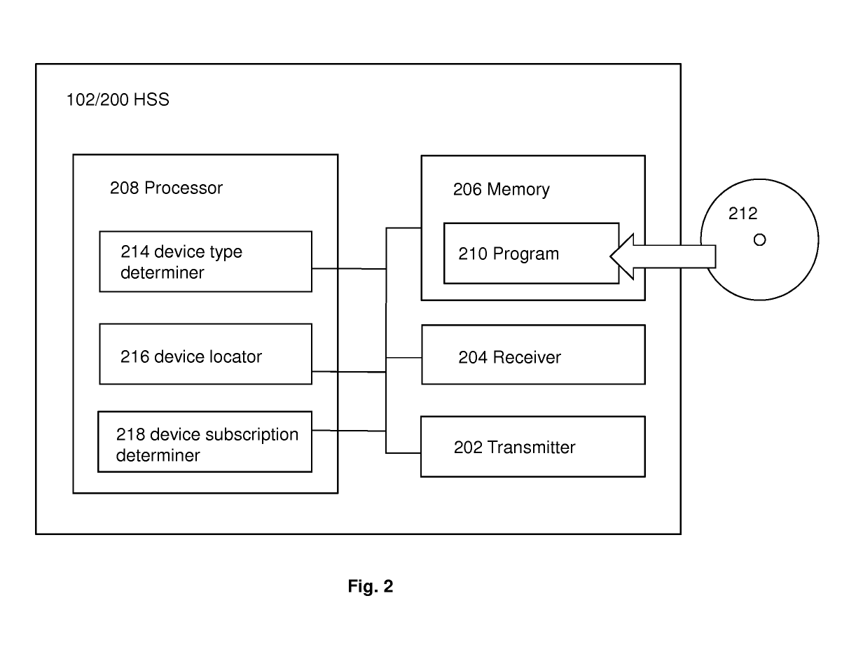

FIG. 2 shows a schematic representation of a network node for implementing a HSS 102, 200. The HSS 200 comprises a transmitter 202 and a receiver 204. The transmitter 202 and receiver 204 may be in data communication with other network entities in a telecommunications network and are configured to transmit and receive data accordingly.

The HSS 200 further comprises a memory 206 and a processor 208. The memory 206 may comprise a non-volatile memory and/or a volatile memory. The memory 206 may have a computer program 210 stored therein. The computer program 210 may be configured to undertake the methods disclosed herein. The computer program 210 may be loaded in the memory 206 from a non-transitory computer readable medium 212, on which the computer program is stored. The processor 208 is configured to undertake one or more of the functions of a device type determiner 214, a device locator 216 and a device subscription determiner 218, as set out below. Further, the memory 206 may be configured to store device data relating to one or more device identifiers and optionally comprising a device type and an IMS subscription type for each device identifier.

Each of the transmitter 202 and receiver 204, memory 206, processor 208, device type determiner 214, device locator 216 and device subscription determiner 218 is in data communication with the other features 202, 204, 206, 208, 210, 214, 216, 218 of the HSS 200. The HSS 200 can be implemented as a combination of computer hardware and software. In particular, the device type determiner 214, device locator 216 and device subscription determiner 218 may be implemented as software configured to run on the processor 208. The memory 206 stores the various programs/executable files that are implemented by a processor 208, and also provides a storage unit for any required data. The programs/executable files stored in the memory 206, and implemented by the processor 208, can include the device type determiner 214, device locator 216 and device subscription determiner 218, but are not limited to such.

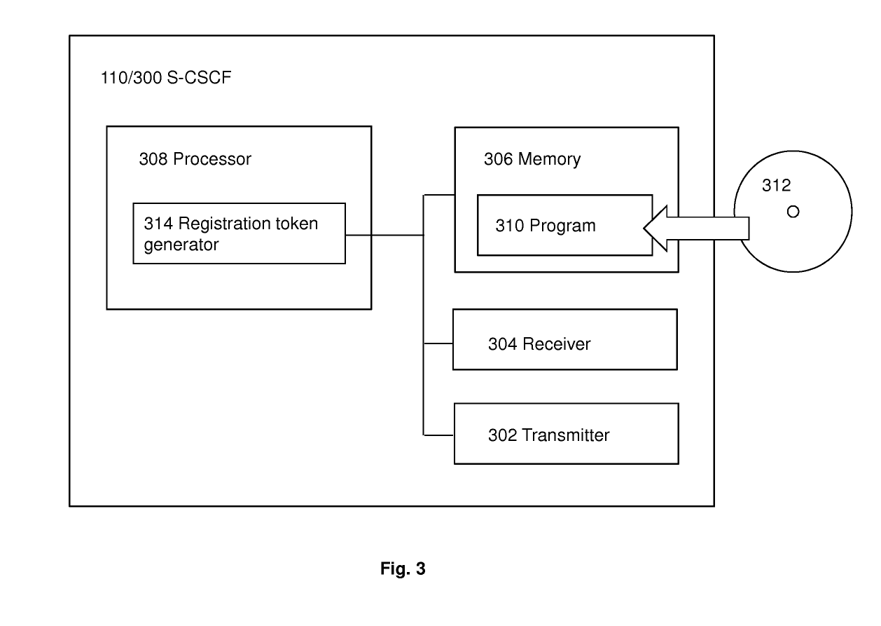

FIG. 3 shows a schematic representation of a network node for implementing a S-CSCF 110, 300. The S-CSCF 300 comprises a transmitter 302 and a receiver 304. The transmitter 302 and receiver 304 may be in data communication with other network entities in a telecommunications network and are configured to transmit and receive data accordingly.

The S-CSCF 300 further comprises a memory 306 and a processor 308. The memory 306 may comprise a non-volatile memory and/or a volatile memory. The memory 306 may have a computer program 310 stored therein. The computer program 310 may be configured to undertake the methods disclosed herein. The computer program 310 may be loaded in the memory 306 from a non-transitory computer readable medium 312, on which the computer program is stored. The processor 308 is configured to undertake the function of a registration token generator 314, as set out below.

Each of the transmitter 302 and receiver 304, memory 306, processor 308 and registration token generator 314 is in data communication with the other features 302, 304, 306, 308, 310, 314 of the S-CSCF 300. The S-CSCF 300 can be implemented as a combination of computer hardware and software. In particular, the registration token generator 314 may be implemented as software configured to run on the processor 308. The memory 306 stores the various programs/executable files that are implemented by a processor 308, and also provides a storage unit for any required data. The programs/executable files stored in the memory 306, and implemented by the processor 308, can include the registration token generator 314, but are not limited to such.

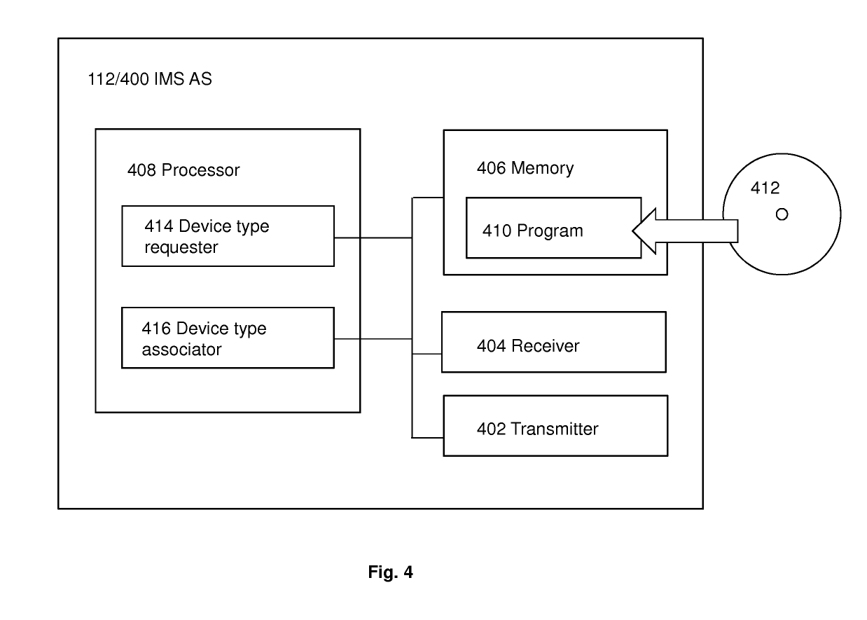

FIG. 4 shows a schematic representation of a network node for implementing a IMS AS 112, 400. The IMS AS 400 comprises a transmitter 402 and a receiver 404. The transmitter 402 and receiver 404 may be in data communication with other network entities in a telecommunications network and are configured to transmit and receive data accordingly.

The IMS AS 400 further comprises a memory 406 and a processor 408. The memory 406 may comprise a non-volatile memory and/or a volatile memory. The memory 406 may have a computer program 410 stored therein. The computer program 410 may be configured to undertake the methods disclosed herein. The computer program 410 may be loaded in the memory 406 from a non-transitory computer readable medium 412, on which the computer program is stored. The processor 408 is configured to undertake one or more of the functions of a device type requester 414 and a device type associator 416, as set out below.

Each of the transmitter 402 and receiver 404, memory 406, processor 408, device type requester 414 and device type associator 416 is in data communication with the other features 402, 404, 406, 408, 410, 414, 416 of the IMS AS 400. The IMS AS 400 can be implemented as a combination of computer hardware and software. In particular, the device type requester 414 and device type associator 416 may be implemented as software configured to run on the processor 408. The memory 406 stores the various programs/executable files that are implemented by a processor 408, and also provides a storage unit for any required data. The programs/executable files stored in the memory 406, and implemented by the processor 408, can include the device type requester 414 and the device type associator 416, but are not limited to such.

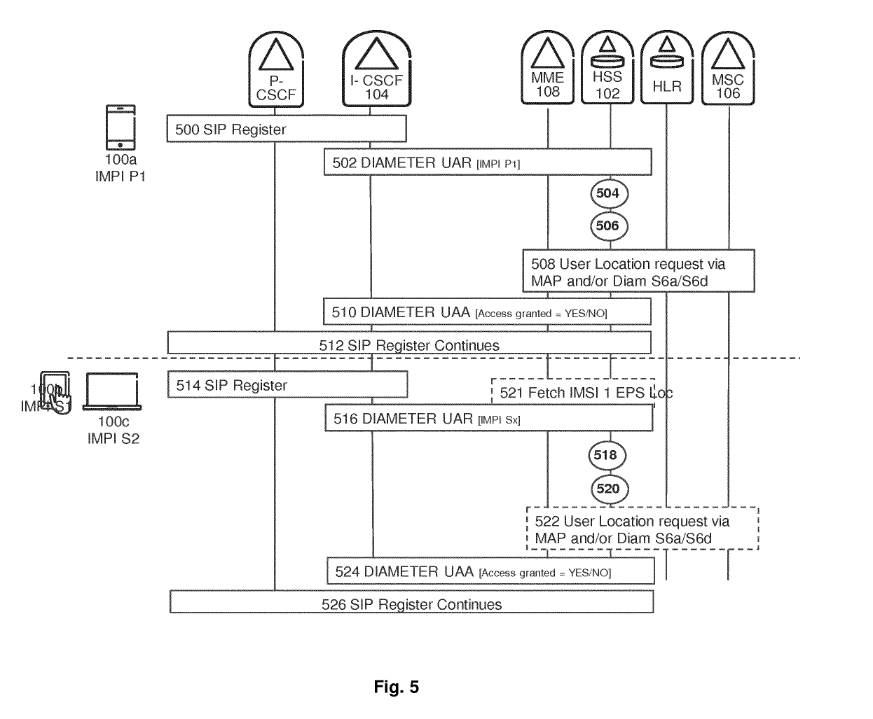

FIG. 5 shows a signaling diagram for IMS access authorization of a UE or user device 100a in an IMS network.

The HSS 102 executes authorization policies to the IMS domain. Some of these policies can be based on the location where the corresponding user is accessing from. However, in WiFi calling, an authorization message (e.g. DIAMETER User Authorization Request (UAR)), which may comprise SIP/Diameter signaling, might not include any useful information to determine a roaming status or location information for the device 100a. This is because the P-CSCF is always in the Home Public Land Mobile Network (HPLMN) in a WiFi Calling scenario.

The only location information available to the HSS 102 is the User Provided Location Information (UPLI) included in the SIP Register message by the UE 100a. When the UPLI is not considered to be sufficient to base access authorization policies on, it has been suggested that location of the user in the 3GPP cellular network may be used instead. This requires that at reception of an authorization message at the HSS 102, the location of the user, if any, in the CS or Mobile Switching Center (MSC) server, the PS or Serving GPRS Support Node (SGSN) and/or in the Evolved Packet System (EPS) or Mobile Management Entity (MME) is fetched over Mobile Application Part (MAP) or S6a/S6d reference points. This is however only applicable to UAR signaling related to user access from primary devices. Exemplary methods and apparatus may make use of the new indication for primary/secondary device types defined herein, as shown in FIG. 5.

The HSS 102 comprises multi-subscription data for a user with a plurality of devices 100a, 100b, 100c. The multi-subscription data comprises a private identifier assigned for each of the plurality of devices and a common set of one or more public identifiers associated with the private identifiers assigned for the plurality of devices.

The UE 100a transmits 500 a SIP register message to an Interrogating Call Session Control Function (I-CSCF) 104.

The I-CSCF 104 transmits 502 an authorization message, such as a DIAMETER UAR, to the HSS 102. The authorization message comprises a private identifier, such as an IMPI, associated with the device 100a and a public identifier included in the common set of public identifiers.

The receiver 204 of the HSS 102 receives the authorization message. The device type determiner 214 determines 504 the device type of the user device 100a based on the private identifier included in the authorization message and the multi-subscription data. The device type may indicate an access capability for the device 100a.

The memory 206 of the HSS 102 may store device type data indicating the device type of a plurality of devices based on private identifiers associated with those devices. The device type determiner 214 may determine the device type of the device 100a based on the device type data.

Alternatively, if access subscription data is available for an access network through which the device 100a can access the IMS, e.g. data in the access profile assigned for the device as commented above, the device type determiner 214 may determine the device type based on the access subscription data. If access subscription data is not available for the device 100a, the device type determiner 214 may determine a device type indicating a direct access capability, e.g. a SIP/Web client in the device for access though internet, to access the IMS for the device related to the multi-subscription.

The device subscription determiner 218 may determine 506 a multi-subscription indicator based on the private identifier and the multi-subscription data. The multi-subscription indicator indicates whether the device 100a is part of a multi-subscription.

Based on at least one of the device type and the multi-subscription indicator indicating that the device is part of a multi-subscription, the device locator 216 may control the transmitter 202 to transmit 508 a message requesting location data for the device 100a.

The receiver 204 of the HSS 102 receives data indicating the location of the device 100a and the HSS 102 transmits 510 a response to the authorization message to the I-CSCF 104. The response may be a DIAMETER UAA message. SIP registration continues at 512.

In the exemplary case shown at the top of FIG. 5, the device 100a is a P1 device. Once the device type determiner 214 has determined the device type, the device locator 216 can infer that the device 100a has 3GPP access capabilities and so controls the transmitter to transmit 504 to an MSC 106 a request for the location of the device 100a.

In another example shown at the bottom of FIG. 5, a secondary device, such as an S1 device 100b or a S2 device 100c transmits 514 a SIP register message to the I-CSCF 104.

The I-CSCF 104 transmits 516 an authorization message, which is received by the receiver 204 of the HSS 102. The device type determiner 214 may determine 518 the device type of the device 100b, 100c, as discussed above. The device subscription determiner 218 may determine 520 a multi-subscription indicator as discussed above.

As the device 100b, 100c is a secondary device, the location of the device 100b, 100c cannot be determined in the same way as for the P1 device 100a. In this example, the device locator 216 may decide not to obtain location data or may decide to obtain the location of the P1 device 100a associated with the multi-subscription and use that for authorization purposes.

If location of the P1 device 100a is to be used, the device locator 216 determines the P1 device 100a associated with the multi-subscription based on device multi-subscription data stored in the memory 206 of the HSS 102. The device locator 216 obtains 521 an identity, such as the International Mobile Subscriber Identity (IMSI), of the P1 device 100a from the MME 108 by controlling the transmitter 202 to transmit a request to the MME 108 and receiving a response at the receiver 204. The device locator 216 then obtains the location of the P1 device 100a by transmitting 522 a request to the MSC 106 using the obtained IMSI of the P1 device 100a.

The receiver 204 of the HSS 102 receives data indicating the location of the P1 device 100a and the HSS 102 transmits 524 a response to the authorization message to the I-CSCF 104. The response may be a DIAMETER UAA message. SIP registration continues at 526.

At reception of UAR Requests related to P1 devices 100a, the HSS 102 may be configured to check the user access profile for the corresponding IMPI of the P1 device 100a finding the device marked as a primary device and therefore fetching of NPLI that is applicable.

However, at reception of UAR Requests related to secondary devices 100b, 100c, the HSS 102 may be configured to find the device marked as secondary devices in the user access profile related to the IMPI included in the UAR and could therefore apply access control policies not considering the cellular location of the user from that secondary device.

Default policies could be applied (e.g. based on UPLI included in SIP/Diameter signaling). Alternatively, the HSS 102 may apply access policies for IMS access attempts for secondary devices 100b, 100c based on the cellular location of the primary device 100a instead (e.g. NPLI requests using IMSI P1 of the P1 device 100a).

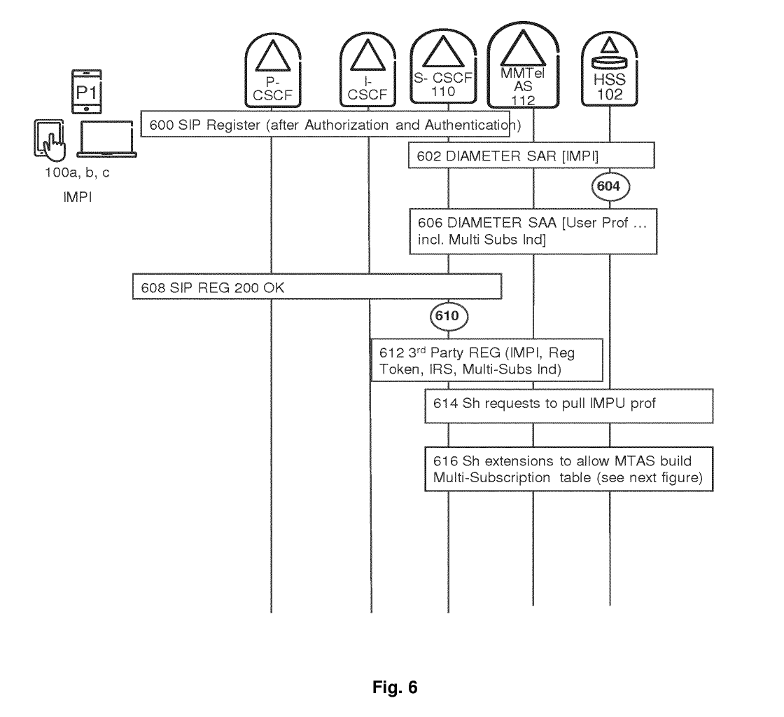

FIG. 6 shows a signaling diagram for SIP registration after authorization.

After IMS authorization, such as shown in the exemplary signaling flows of FIG. 5, IMS registration continues and during that continued IMS registration, an S-CSCF 110 may download from the HSS 102 an IMS user service profile for the IMPI/IMPUs associated with the devices 100a, 100b, 100c being registered. The information downloaded from the HSS 102 may include the list of IMPUs implicitly registered (including the default IMPU which will be used in call cases) and Initial Filter Criteria (IFC) indicating which ASs shall be involved for the device being registered.

In exemplary methods and apparatus, the HSS 102 additionally provides the S-CSCF 110 with an indication whether a given IMPI being registered belongs to an IMS multi-subscription and that this indication could be also be forwarded to relevant IMS ASs.

A P1, S1 or S2 device 100a, 100b, 100c transmits 600 a SIP Register message to the S-CSCF 110. The SIP register message includes a private identifier such as an IMPI for the device and is transmitted after IMS authorization and authentication.

The receiver 304 of the S-CSCF 110 receives the SIP Register message from the device 100a, 100b, 100c and the transmitter 302 transmits 602 a server assignment request message, which may be a DIAMETER Server Assignment Request (SAR) message, to the HSS 102. The server assignment request message includes the IMPI and a public identifier for the device 100a, 100b, 100c, such as an IMPU.

The receiver 204 of the HSS 102 receives the server assignment request message and the device subscription determiner 218 determines (604) a multi-subscription indicator for the device 100a, 100b, 100c based on the IMPI and the multi-subscription data stored in the HSS 102. That is, the device subscription determiner 218 uses the IMPI to search the multi-subscription data stored in the memory 206 of the HSS 102 to determine the multi-subscription indicator. The multi-subscription indicator indicates whether the received private identifier is related to a multi-subscription

The device subscription determiner 218 controls the transmitter 202 to transmit 606 a response to the S-CSCF 110. The response may be a DIAMETER Server Assignment Answer (SAA) message. The response includes the multi-subscription indicator. The response is received by the S-CSCF 110, which transmits 608 a SIP registration OK message to the device 100a, 100b, 100c.

The registration token generator 314 of the S-CSCF 110 determines 610 whether a Reg Token is required based on the response. The registration token determiner may be configured to determine that a registration token, illustrated as Reg Token, is only required for devices 100a, 100b, 100c that belong to a multi-subscription and are indicated as such by the multi-subscription indicator included in the response. This saves computing resources in the S-CSCF 110 and IMS AS for single IMS subscriptions. If the registration token generator 314 determines that a registration token is required, it generates the registration token and, alternatively, may or not include the multi-subscription indicator in the registration token. The registration token generator 314 controls the transmitter 302 to transmit 612 the registration token and the multi-subscription indicator, included or not in the registration token, to an IMS AS 112. In the exemplary case of FIG. 6, the IMS AS is an MMTel AS 112.

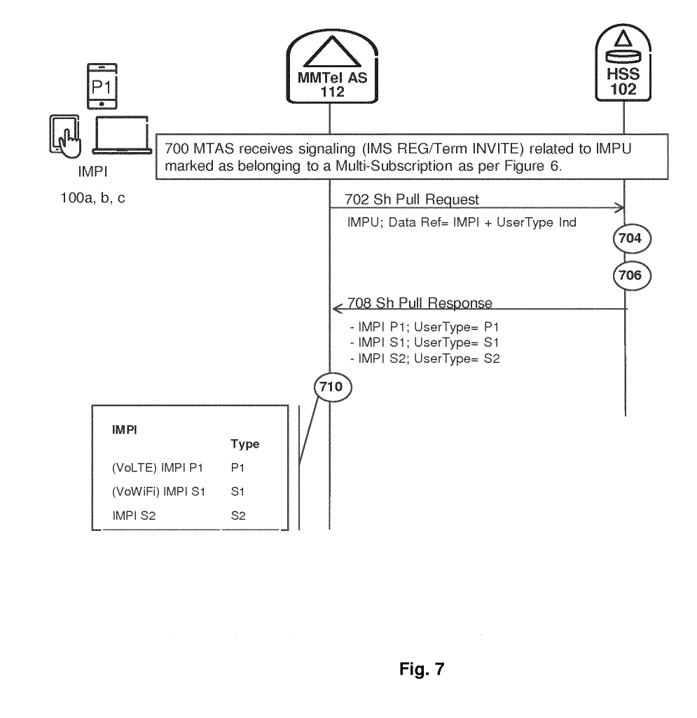

When received from the S-CSCF 110, the multi-subscription indicator can be used at the IMS AS to trigger additional Sh interactions 614, 616 for building within the MMTel AS 112 a record of the IMS multi-subscription. This is shown in more detail in FIG. 7.

The new Sh interaction(s) disclosed herein allow the building in the IMS AS of an image of the IMS multi-subscription structure related to a given IMPU based on an existing possibility to request the IMPI(s) associated with a given IMPU.

Using Sh request(s), an IMS AS is able to receive a list of all IMPIs related to an IMPU. In addition, methods and apparatus disclosed herein propose that an Sh request includes an indicator requesting the device type associated with each IMPI as stored in the HSS 102. With this enhancement, the IMS AS will be able to execute subsequent Sh requests using appropriate IMPIs and optimize procedures for signaling related to secondary devices.

As FIG. 7 illustrates, at 700, the procedure detailed in FIG. 6 is undertaken. The receiver 404 of the MMTel AS 112 therefore receives the registration token and the multi-subscription indicator, included or not in the registration token, from the S-CSCF 110. The device type requester 414 of the MMTel AS 112 controls the transmitter 402 to transmit 702 a request for device data from the HSS 102. The request may be a Sh pull request. The request may include an IMPU relating to a plurality of devices of a multi-subscription identified in, or along with, the registration token received from the S-CSCF 110 and may request the IMPI and device type of a plurality of the devices related to the multi-subscription.

The HSS 102 receives the request and the device type determiner 214 determines 704 the IMPIs of the devices related to the multi-subscription based on the received IMPU and the multi-subscription data stored at the HSS 102. The device type determiner 214 also determines 706 a device type for each device. If access subscription data is available for an access network through which one or more devices related to the multi-subscription can access the IMS, the device type determiner 214 may determine the device types based on the access subscription data and the multi-subscription data. If access subscription data is not available, the device type determiner 214 may determine the device types as indicating a direct access capability to access the IMS for each of these one or more devices related to the multi-subscription based on the multi-subscription data.

The HSS 102 transmits 708 to the MMTel AS 112 a response to the request. The response may be a Sh pull response. The response includes the IMPI and the device type for a plurality of devices related to the multi-subscription.

The device type associator 416 of the MMTel AS 112 may use the received IMPI and device type data to generate a table 710.

During Originating and Terminating Call procedures, the MMTel AS supports charging and executes barring services. Using the methods and apparatus disclosed herein, the MMTel AS 112 may determine if an originating INVITE for a call is sent from a primary or secondary device. Similarly, the MMTel AS 112 and SCC AS will be able to complete terminating call legs appropriately for primary and secondary devices.

Charging is dependent on access network information received from a PCC/P-CSCF. Access-types applicable for S1 and S2 devices can be determined based on provisioned device types fetched from the HSS 102 without the need to receive information from the PCC/P-CSCF. Service execution, charging, and barring are dependent on user location information. For P1 devices NPLI may be requested from the HSS 102 during originating and terminating procedures.

Similar needs to distinguish signaling for primary or secondary devices in use by IMS users apply also for Terminating calls, but the reception of a Terminating INVITE requests when the IMPU is in an UNREGISTERED state deserves special attention. In this situation, the MMTel AS 112 is not aware that the IMPU is related to an IMS multi-subscription and does not yet have information about the related IMPIs and corresponding device types.

Methods and apparatus disclosed herein propose that the multi-subscription indicator at IMPU level stored within an IMS Telephony service profile in the HSS 102 as transparent data is used to help the MMTel AS 112 to build the multi-subscription structure for this use case.

Once the MMTel AS 112 has received the multi-subscription information (including IMPIs and device types per IMPI related to a given IMPU) either built up during IMS REG or during Terminating Call procedures for UNREGISTERED IMPUs, the MMTel AS 112 can apply barring and charging for terminating legs towards P1, S1 and S2 devices.

Terminating call legs for P1 devices can use location information from the corresponding P1 device and access information from a PCC architecture. Additionally, as TADS and CS break out for these devices may apply, the MMTel AS 112 could characterize the INVITE towards the SCC AS, so these procedures can be triggered appropriately for P1 devices. One way to achieve this could be to include the IMPI (e.g. Accept-Contact: +impi=<IMPI-value>) and a P1 indication (e.g. Accept-Contact: “mobility”=cs-mobile) within the INVITE for P1 terminating call legs.

Terminating call legs for S1 and/or S2 devices could progress without triggering location information requests from the HSS 102 and using the access type information corresponding to the device type of the corresponding IMPI (i.e. without waiting for access information from the PCC/P-CSCF). Terminating call legs for S1 and/or S2 devices shall not trigger TADS or CS break out in the SCC AS, so in this case MMTel AS 112 will not need to include any additional info in the INVITE as it does for P1 devices.

A computer program may be configured to provide any of the above described methods. The computer program may be provided on a computer readable medium. The computer program may be a computer program product. The product may comprise a non-transitory computer usable storage medium. The computer program product may have computer-readable program code embodied in the medium configured to perform the method. The computer program product may be configured to cause at least one processor to perform some or all of the method.

Various methods and apparatus are described herein with reference to block diagrams or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

Computer program instructions may also be stored in a computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, the invention may be embodied in hardware and/or in software (including firmware, resident software, micro-code, etc.) that runs on a processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated.

The skilled person will be able to envisage other embodiments without departing from the scope of the appended claims.

1. A network node for use as a Home Subscriber Server, HSS, in an Internet Protocol Multimedia Subsystem, IMS, wherein the network node comprises multi-subscription data for a user with a plurality of devices, the multi-subscription data comprising a private identifier assigned for each of the plurality of devices and a common set of one or more public identifiers associated with each private identifier assigned for each of the plurality of devices, the network node comprising:
a receiver configured to receive from a further node a message for assigning a server in the IMS to one of the plurality of devices, the message comprising a private identifier for the device and a public identifier included in the common set of one or more public identifiers; and
a device subscription determiner configured to determine, based on the received private identifier and the multi-subscription data, a multi-subscription indicator indicating whether the received private identifier is related to a multi-subscription, and to control a transmitter to transmit to the further node a response to the received message, the response comprising the multi-subscription indicator.

2. A network node according to claim 1, wherein the multi-subscription data further comprises a subscription type assigned for each of the plurality of devices, the subscription type indicating that the device is related to the multi-subscription, and wherein the device subscription determiner is further configured to determine, based on the received private identifier and the subscription type assigned for the device, the multi-subscription indicator for inclusion in the response.

3. A network node according to claim 1, wherein
the receiver is configured to receive from an IMS Application Server, IMS AS, a request for a private identifier and a device type for each device related to the multi-subscription, the request comprising a public identifier included in the common set of one or more public identifiers; and the network node further comprising:
a device type determiner configured to:
determine, based on the received public identifier and the multi-subscription data, the private identifier for each device related to the multi-subscription;
if access subscription data is available for an access network through which one or more devices related to the multi-subscription can access the IMS, determine, based on the access subscription data and the multi-subscription data, a device type indicating an access capability for each of these one or more devices related to the multi-subscription;
if access subscription data is not available for one or more devices related to the multi-subscription, determine, based on the multi-subscription data, a device type indicating a direct access capability to access the IMS for each of these one or more devices related to the multi-subscription; and
control the transmitter to transmit the determined private identifiers and device types to the IMS AS.

4. A network node according to claim 1, wherein the multi-subscription data further comprises a device type assigned for each of the plurality of devices, the device type indicating an access capability of each device, and wherein
the receiver is configured to receive from an IMS Application Server, IMS AS, a request for a private identifier and a device type for each device related to the multi-subscription, the request comprising a public identifier included in the common set of one or more public identifiers, and the network node further comprising:
a device type determiner configured to determine the private identifier and the device type for each device related to the multi-subscription, based on the received public identifier and the multi-subscription data, and to control the transmitter to transmit the determined private identifiers and device types to the IMS AS.

5. A network node according to claim 3, wherein the device types indicate an access capability of a device as one or more of: cellular access; circuit switched access; Wi-Fi access; Evolved Packet System, EPS; and internet access.

6. A method for operating a network node for use as a Home Subscriber Server, HSS, in an Internet Protocol Multimedia Subsystem, IMS, wherein the network node comprises multi-subscription data for a user with a plurality of devices, the multi-subscription data comprising a private identifier assigned for each of the plurality of devices and a common set of one or more public identifiers associated with each private identifier assigned for each of the plurality of devices, the method comprising:
receiving, by a receiver from a further node, a message for assigning a server in the IMS to one of the plurality of devices, the message comprising a private identifier for the device and a public identifier included in the common set of one or more public identifiers; and
determining, by a device subscription determiner and based on the received private identifier and the multi-subscription data, a multi-subscription indicator indicating whether the received private identifier is related to a multi-subscription; and
controlling, by the device subscription determiner, a transmitter to transmit to the further node a response to the received message, the response comprising the multi-subscription indicator.

7.-10. (canceled)

11. A computer program comprising instructions which, when executed on at least one processor, cause the at least one processor to carry out the method according to claim 6.

12. (canceled)

13. A network node for use as a Serving Call Session Control Function, S-CSCF, in an Internet Protocol Multimedia Subsystem, IMS, wherein a user with a plurality of devices holds a subscription in a Home Subscriber Server, HSS, of the IMS, the subscription comprising a private identifier assigned for each of the plurality of devices and one or more public identifiers associated with the private identifiers assigned for the plurality of devices, the network node comprising:
a transmitter configured to transmit to the HSS a message for assigning a server in the IMS to a device, the message comprising a private identifier and a public identifier for the device;
a receiver configured to receive a response to the transmitted message, the response comprising a multi-subscription indicator indicating whether the device is related to a multi-subscription; and
a registration token generator configured to generate a registration token for the device in dependence on the received multi-subscription indicator indicating that the device is related to a multi-subscription,
the registration token generator being further configured to control the transmitter to transmit the registration token and the multi-subscription indicator to an IMS Application Server, IMS AS.

14. A network node according to claim 13, wherein the registration token comprises the multi-subscription indicator.

15. A method for operating a network node for use as a Serving Call Session Control Function, S-CSCF, in an Internet Protocol Multimedia Subsystem, IMS, wherein a user with a plurality of devices holds a subscription in a Home Subscriber Server, HSS, of the IMS, the subscription comprising a private identifier assigned for each of the plurality of devices and one or more public identifiers associated with the private identifiers assigned for the plurality of devices, the method comprising:
transmitting, by a transmitter to the HSS, a message for assigning a server in the IMS to a device, the message comprising a private identifier and a public identifier for the device;
receiving, by a receiver, a response to the transmitted message, the response comprising a multi-subscription indicator indicating whether the device is related to a multi-subscription;
generating, by a registration token generator, a registration token for the device in dependence on the received multi-subscription indicator indicating that the device is related to a multi-subscription; and
controlling, by the registration token generator, the transmitter to transmit the registration token and the multi-subscription indicator to an IMS Application Server, IMS AS.

16. (canceled)

17. A computer program comprising instructions which, when executed on at least one processor, cause the at least one processor to carry out the method according to claim 15.

18. (canceled)

19. A network node for use as an Internet Protocol Multimedia Subsystem Application Server, IMS AS, in an IMS, wherein a user with a plurality of devices holds a subscription in a Home Subscriber Server, HSS, of the IMS, the subscription comprising a private identifier assigned for each of the plurality of devices and one or more public identifiers associated with the private identifiers assigned for the plurality of devices, the network node comprising:
a receiver configured to receive from a further node a registration token for a device, and a multi-subscription indicator indicating whether the device is related to a multi-subscription;
a device type requester configured to control a transmitter to transmit a request to the HSS, the request being for a private identifier and a device type for each device related to the multi-subscription, the request comprising a public identifier for the device,
wherein the receiver is further configured to receive from the HSS the requested private identifiers and device types related to the multi-subscription; and
a device type associator configured to associate each private identifier with a device type related to the multi-subscription.

20. A network node according to claim 19, wherein the registration token comprises the multi-subscription indicator.

21. A method for operating a network node for use as an Internet Protocol Multimedia Subsystem Application Server, IMS AS, in an IMS, wherein a user with a plurality of devices holds a subscription in a Home Subscriber Server, HSS, of the IMS, the subscription comprising a private identifier assigned for each of the plurality of devices and one or more public identifiers associated with the private identifiers assigned for the plurality of devices, the method comprising:
receiving, by a receiver from a further node, a registration token for a device, and a multi-subscription indicator indicating whether the device is related to a multi-subscription;
controlling, by a device type requestor, a transmitter to transmit a request to the HSS, the request being for a private identifier and a device type for each device related to the multi-subscription, the request comprising a public identifier for the device;
receiving, by the receiver and from the HSS, the requested private identifiers and device types related to the multi-subscription; and
associating, by a device type associator, each private identifier with a device type related to the multi-subscription.

22. (canceled)

23. A computer program comprising instructions which, when executed on at least one processor, cause the at least one processor to carry out the method according to claim 21.

24. (canceled)

25. A network node for use as a Home Subscriber Server, HSS, in an Internet Protocol Multimedia Subsystem, IMS, wherein the network node comprises multi-subscription data for a user with a plurality of devices, the multi-subscription data comprising a private identifier assigned for each of the plurality of devices and a common set of one or more public identifiers associated with the private identifiers assigned for the plurality of devices, the network node comprising:
a receiver configured to receive from a further node a message for authorising a device in the IMS, the message comprising a private identifier for the device and a public identifier included in the common set of one or more public identifiers;
a device type determiner configured to determine a device type for the device based on the received private identifier and the multi-subscription data, the device type indicating an access capability for the device to access the IMS;
a device subscription determiner configured to determine, based on the received private identifier and the multi-subscription data, a multi-subscription indicator indicating that the received private identifier is related to a multi-subscription; and
a device locator configured, in dependence on at least one of the device type and the multi-subscription indicator indicating the multi-subscription, to
transmit, via a transmitter, a message requesting location data for one or more devices related to the multi-subscription and
receive, via the receiver, location data for at least one of the one or more devices related to the multi-subscription,
wherein the transmitter is configured to transmit to the further node a response to the received message, the response being based on the location data received for the at least one of the one or more devices related to the multi-subscription.

26. A network node according to claim 25, wherein the device type determiner is configured to:
if access subscription data is available for an access network through which the device can access the IMS, determine, based on the access subscription data, a device type indicating an access capability for the device related to the multi-subscription;
if access subscription data is not available for the device, determine a device type indicating a direct access capability to access the IMS for the device related to the multi-subscription.

27. A network node according to claim 25, wherein the multi-subscription data further comprises a device type assigned for each of the plurality of devices; and wherein
the device type determiner is configured to determine the device type assigned for the device.

28. A network node according to claim 25, wherein the multi-subscription data further comprises a subscription type assigned for each of the plurality of devices, the subscription type indicating that the device is related to the multi-subscription, and wherein the device subscription determiner is configured to determine the multi-subscription indicator based on the subscription type assigned for the device.

29. A network node according to claim 25, wherein the device types indicate an access capability of a device as one or more of: cellular access; circuit switched access; Wi-Fi access; Evolved Packet System, EPS; and internet access.

30. A network node according to claim 29, wherein the device locator is configured to transmit the request for location data relating to the device in dependence on the device having a cellular access capability.

31. A network node according to claim 29, wherein, if the device does not have a cellular access capability, the device locator is configured to transmit the request for location data relating to a different device related to the multi-subscription and having a cellular access capability.

32. A method for operating a network node for use as a Home Subscriber Server, HSS, in an Internet Protocol Multimedia Subsystem, IMS, wherein the network node comprises multi-subscription data for a user with a plurality of devices, the multi-subscription data comprising a private identifier assigned for each of the plurality of devices and a common set of one or more public identifiers associated with the private identifiers assigned for the plurality of devices, the method comprising:
receiving, by a receiver and from a further node, a message for authorising a device in the IMS, the message comprising a private identifier for the device and a public identifier included in the common set of one or more public identifiers;
determining, by a device type determiner, a device type for the device based on the received private identifier and the multi-subscription data, the device type indicating an access capability for the device to access the IMS;
determining, by a device subscription determiner
and based on the received private identifier and the multi-subscription data, a multi-subscription indicator indicating that the received private identifier is related to a multi-subscription;
in dependence on at least one of the device type and the multi-subscription indicator indicating the multi-subscription, transmitting, by a device locator via a transmitter, a message requesting location data for one or more devices related to the multi-subscription;
receiving, by the device locator via the receiver, location data for at least one of the one or more devices related to the multi-subscription; and
transmitting, by the transmitter and to the further node, a response to the received message, the response being based on the location data received for the at least one of the one or more devices related to the multi-subscription.

33.-38. (canceled)

39. A computer program comprising instructions which, when executed on at least one processor, cause the at least one processor to carry out the method according to claim 32.

40. (canceled)
